(19) United States
(12) Patent Application Publication
(10) Pub. No.: US 2017/0300133 A1
(43) Pub. Date: Oct. 19, 2017

(54) WEARABLE COMPUTING DEVICE

(71) Applicant: HEWLETT-PACKARD DEVELOPMENT COMPANY, L.P., HOUSTON, TX (US)

(72) Inventor: STEVE MORRIS, NES ZIONA (IL)

(21) Appl. No.: 15/511,745

(22) PCT Filed: Dec. 18, 2014
(86) PCT No.: PCT/US2014/071052

§ 371 Date: Mar. 16, 2017

(51) Int. Cl. G06F 3/0338; G06F 3/0487; G06F 1/16

(52) U.S. Cl. CPC G06F 3/0338; G06F 1/163; G06F 3/0487

(57) ABSTRACT

A wearable computing device may comprise a processor, a base portion, an articulation portion movably coupled to the base portion, and an articulation sensor movably coupling the articulation portion to the base portion. The articulation portion may include a display with a graphical user interface to display an image to the user. The articulation sensor may be disposed in between the articulation portion and the base portion, and be substantially centered behind the display. The articulation sensor may detect an articulation direction of the articulation portion and provide an input to the processor based on the detected direction. The processor may output a revised image on the graphical user interface corresponding to the provided input.

### BACKGROUND

Mobile computing devices can perform a variety of functions and execute a variety of applications, similar to a traditional computing system. Mobile computing devices can be carried or worn, sometimes on the wrist of a user in a manner similar to a traditional watch. Mobile computing devices that are worn on the wrist of a user can be known as smart watches. The function or application to be executed by the smart watch can be chosen by the user by selecting the application or function from a display on the smart watch. The display is sometimes located where a traditional watch face would be.

### BRIEF DESCRIPTION OF DRAWINGS

The following detailed description refers to the drawings, wherein:

FIG. 1 is a perspective view of an example wearable computing device.

FIG. 2A is a perspective view of an example wearable computing device including an attachment mechanism and a computing device portion.

FIG. 2B is a side view of an example wearable computing device.

FIG. 3A is a top view of an example wearable computing device with a machine-readable storage medium encoded with instructions.

FIG. 3B is a top view of an example wearable computing device with a display showing multiple applications or functions.

FIG. 3C is a top view of an example wearable computing device with a display showing a visual representation of a secondary function of the wearable computing device.

### DETAILED DESCRIPTION

Mobile computing devices can be worn on the wrist of a user in a manner similar to a watch. Computing devices that are worn in such a manner often physically resemble the size and shape of a traditional watch. Such wearable computing devices can be referred to as smart watches and can execute applications and perform functions beyond timekeeping and in a manner similar to that of other mobile computing devices or traditional computing systems.

A user can operate the wearable computing device through a graphical user interface on a display. The display may be located in a similar location and orientation as the watch face on a traditional watch. The display may show icons that represent applications that the smart watch can execute or other functions that the smart watch can perform. The user can select the application or function through the use of physical buttons on the smart watch. Further, the display may include a touchscreen, allowing the user to interact with the graphical user interface and select functions or applications by touching the display itself.

Smart watches that require a user to utilize physical buttons in order to interact with the graphical user interface often have the buttons on the side of the display or on a side bezel. Having the buttons in such a location may require the user to use at least two figures to actuate each button. One finger may be required to press the button itself, while an additional finger may be required to exert a counterforce on the opposite side of the bezel or display in order to prevent the smart watch from moving along the user's wrist or arm due to the force exerted on the button.

Additionally, the surface area of a smart watch display is sometimes limited, e.g., in order to keep the smart watch display approximately the same size as a traditional watch face. Therefore, a smart watch that utilizes a touch screen to allow the user to interact with the graphical user interface is sometimes limited in how many icons can be visible at once on the display and how large the icons can be. Further, in some situations, the display is largely obscured by the user's finger when the user is interacting with the touch screen.

Implementations of the present disclosure provide a wearable computing device that includes an articulation sensor behind the display. The articulation sensor can determine when a user is using a single finger to provide a force input to the edge or periphery of the display. The force input can be in a location on the periphery of the display such that the display is substantially unobscured by the single finger. The force input can control movement or manipulation of a graphical user interface without substantially obscuring the user's view of the display. Further, the articulation sensor allows an increase in the case or user of the example wearable computing device because it can detect the force input from a single finger. Therefore, only one finger is needed to manipulate the graphical user interface of the example wearable computing device, as opposed to two or more as described above.

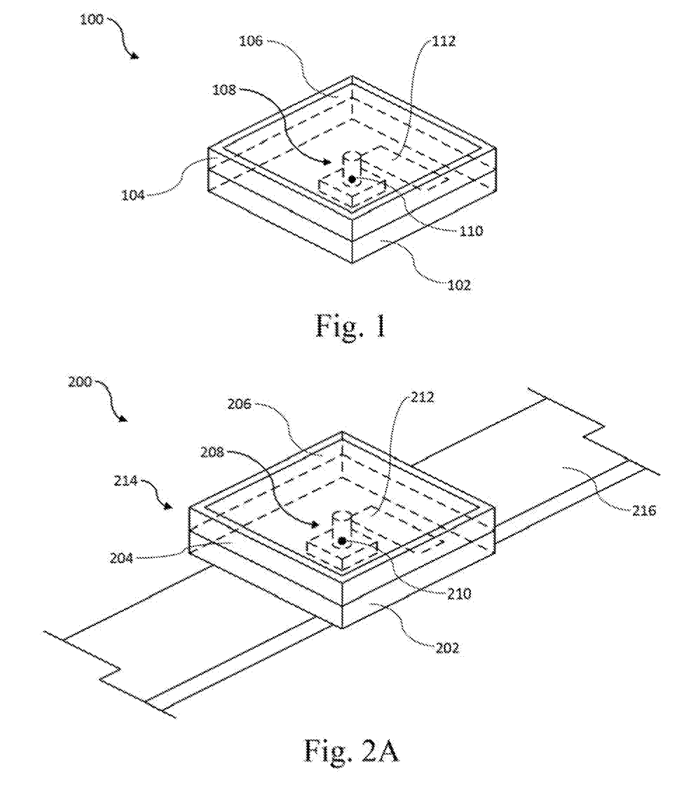

Referring now to FIG. 1, a perspective view of an example wearable computing device 100 is illustrated. The wearable computing device 100 may be attachable to a person or user, and may be device capable of processing an storing data, executing computerized applications, and performing computing device functions. The wearable computing device 100 may include a processor 112 (shown in dotted lines) and additional computing device components including, but not limited to, a camera, a speaker, a microphone, a media player, an accelerometer, a thermometer, an altimeter, a barometer or other internal or external sensors, a compass, a chronograph, a calculator, a cellular phone, a global positioning system, a map, a calendar, email, internet connectivity, Bluetooth connectivity, Near-Field Communication (NFC) connectivity, personal activity trackers, and a battery or rechargeable battery.

In addition to the processor 112, the wearable computing device 100 may further include a base portion 102, an articulation portion 104, and a articulation sensor 108 movably coupling the articulation portion 104 to the base portion 102, the articulation sensor 108 shown in dotted lines. In further implementations, the base portion 102 may include an external shell or case to house some or all of the articulation portion 104, the articulation sensor 108, the processor 112, and additional computing device components. In yet further implementations, the base portion 102 may include a side bezel disposed around the periphery of the wearable computing device 100.

The articulation portion 104 may be movably coupled to the base portion 102 such that the articulation portion 104 may tilt or articulate relative to the base portion 102 about a single point 110. The articulation portion 104 may include a display 106, the single point 110 being located behind the center of the display 106. The display 106 may include a graphical user interface to display an image or a series of images to the user. In some implementations, the display 106 may be an electronic output device for the visual presentation of information. The display 106 may output visual information in response to electronic input it receives from the processor 112. The display 106 may be comprised of one or more or liquid crystal displays (LCDs), light emitting diodes (LEDs), organic LEDs (OLEDs), electronic paper or electronic ink, plasma display panels, or other display technology. In some implementations, the graphical user interface is part of the visual information. In some implementations, the display may include a virtual desktop or mobile operating system interface as part of the graphical user interface. In further implementations, the display may include mechanical or graphical representations of traditional watch components or features, including but not limited to, a chronograph, the date, moon phases, a stopwatch or timer, alarm functions, an escapement, a tourbillon, or luminous paint or tritium illumination of the various features of the display.

Referring still to FIG. 1, the articulation sensor 108 may be an electrical or electromechanical sensor capable of detecting an external force input acting on the articulation sensor 108. The articulation sensor 108 may be capable of detecting a magnitude of the force input. In some implementations, the articulation sensor 108 is capable of detecting an angle or direction component of a force input acting on the articulation sensor 108. In some implementations, the articulation sensor 108 is capable of detecting a force input that is oriented longitudinally through the articulation sensor 108. In some implementations, the articulation sensor 108 may be a joystick sensor. In further implementations, the articulation sensor 108 may be a keyboard pointing stick sensor.

The articulation sensor 108 may be disposed between the articulation portion 104 and the base portion 102, and substantially centered behind the display 106. The articulation sensor 108 may be fixed to the articulation portion 104 such that a force applied to the articulation portion 104 will be transferred to and applied to the articulation sensor 108. Further, the articulation sensor 108 may be fixed to the base portion 102 and may be articulable such that articulation portion 104 may articulate relative to the base portion 102 about the single point 110. The articulation portion 104 may be articulable in 360 degrees around the single point 110. Further, the articulation direction of the articulation portion 104 may be continuously changeable along the entire 360 degree range of motion. In other words, once articulated about the single point 110, the articulation portion 104 can be articulated in a different direction without the articulation portion 104 returning to a resting position.

Upon the articulation portion 104 articulating relative to the base portion 102, the articulation sensor 108 may detect an articulation direction of the articulation portion 104. The articulation sensor 108 may then provide an input to the processor 112 base on or corresponding to the deleted articulation direction of the articulation portion 104. In some implementations, the articulation portion 104 may articulate about the single point 110 upon the user applying a force input to a single location along the periphery of the display, the articulation portion 104 articulating in a direction towards the location of the force input. In some implementations, the force input may be substantially perpendicular to the display 106. The periphery of the display may refer to any location on the display or the top face of the articulation portion 108 that is radially outside of the center of the display such that the application of such a force will apply a torque or moment to the articulation sensor 108.

The articulation sensor 108 may be further movable in a longitudinal direction that is substantially perpendicular to the base portion 102 and to the display 106 when the articulation portion 104 is unarticulated. The articulation sensor 108 may be movable in a longitudinal direction such that the articulation portion 104 may translate in a substantially perpendicular direction relative to the base portion 102 upon a user applying a substantially perpendicular force input to a single location substantially in the center of the display 106. Upon the articulation portion 104 translating in a substantially perpendicular direction to the base portion 102, the articulation sensor 108 may detect such a translation and then provide an input to the process 112 based on the detected translation. A single location substantially in the center of the display 106 may refer to any location that is within the periphery of the display 106 such that the application of such a force will cause a longitudinal translative movement of the articulation sensor 108 and will not apply a torque or moment to the articulation sensor 108 that is significant enough to articulate the articulation portion 104.

In further implementations, the articulation sensor 108 may detect a user applying a substantially perpendicular force input to a single location substantially in the center of the display 106 without the articulation portion 104 translating in a substantially perpendicular direction to the base portion 102. Upon detecting such a force input to the single location substantially in the center of the display, the articulation sensor 108 may provide an input to the processor 112 based on or corresponding to the detected force input.

The processor 112 may include electrical circuitry capable of executing logic. In some implementations, the processor 112 may be a hardware device containing one or more integrated circuits, the hardware device capable of the retrieval and execution of instructions stored in a machine-readable storage medium. The processor 112 may receive an external input, retrieve, decode and execute the instructions stored in the machine-readable storage medium, and provide an output. The output may correspond to the given input and the retrieved instructions that were executed by the processor 112. In yet further inplementations, the processor 112 may be a semiconductor-based microprocessor or a microcontroller.

Additionally, the processor 112 may be part of the articulation portion 104 such that the processor 112 moves with the articulation portion 104. In further implementations, the processor 112 may be disposed on the base portion 102 such that the processor 112 is fixed and the articulation portion 104 articulates relative to the processor 112. Further, in some implementations, the processor 112 may be disposed within an external case, shell, or side bezel included in the base portion 102.

In further implementations, the processor 112 may output an image to the graphical user interface on the display 106. Additionally, the processor 112 may output a revised image on the graphical user interface upon receiving the provided input from the articulation sensor 108. In some implementations, the revised image may include visual changes to the graphical user interface. In some implementations, the revised image may correspond to the input provided by the articulation sensor 108, e.g., the revised image may correspond to the detected articulation direction of the articulation portion 104. In yet further implementations, the revised image may correspond to the detected perpendicular force input to the center of the display 106, or the translation of the articulation portion 104 as a result of such a force input.

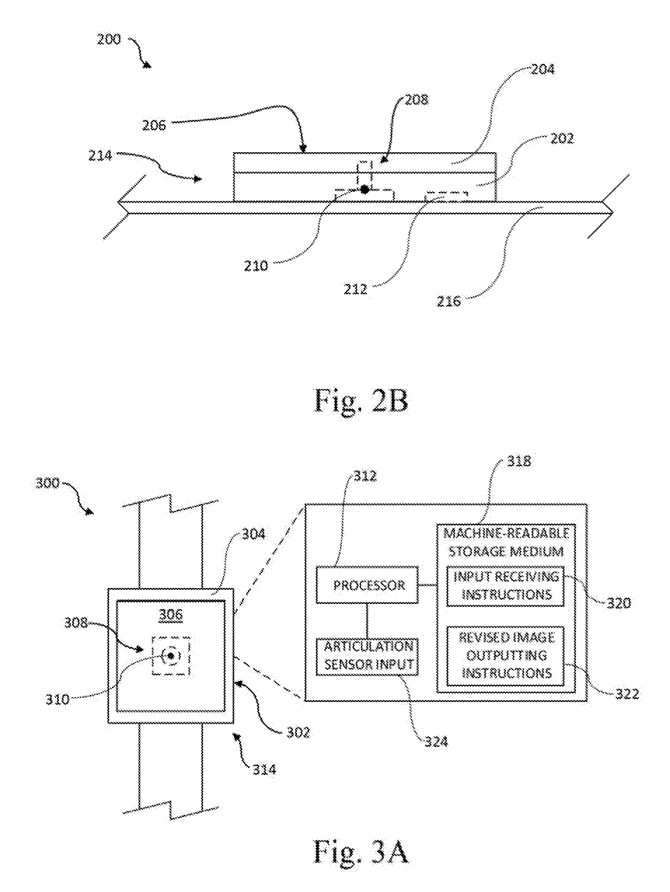

Referring now to FIGS. 2A-2B, a perspective view and a side view of an example wearable computing device 200 is illustrated, respectively. Wearable computing device 200 may be similar to wearable computing device 100. Further, the similarly named elements of wearable computing device 200 may be similar in function to the elements of wearable computing device 100, as they are described above. The wearable computing device 200 may include an attachment mechanism 216 to removably fix the wearable computing device 100 to a person or user, and a computing device portion 214 coupled or fixed to the attachment mechanism 216. The computing device portion 214 may include a base portion 202 and an articulation portion 204 and may be permanently or removably coupled to the attachment mechanism 216 such that the computing device portion 214 is removably fixed to the user through the attachment mechanism 216. In some implementations, the computing device portion 214 may be fixed to the attachment mechanism 216 through the base portion 202.

The attachment mechanism 216 may be a wrist strap or bracelet to removably fix the wearable computing device 220 to a user. The attachment mechanism 216 may include a buckle, Velcro, or a mechanical or other mechanism to allow the attachment mechanism 216 to be fastened to a user and also removed from the user. In some implementations, the attachment mechanism 216 may be a wrist strap and may fasten the wearable computing device 216 to a user by being removably fixed to itself, thereby forming a loop to surround a wrist, arm, or other appendage of the user. In further implementations, the attachment mechanism 216 may wholly or partially be comprised of leather, rubber, steel, aluminum, silver, gold, titanium, nylon or another fabric, or another suitable material. In yet further implementations, the attachment mechanism 216 may include any suitable mechanism for attaching the wearable computing device 200 to the user.

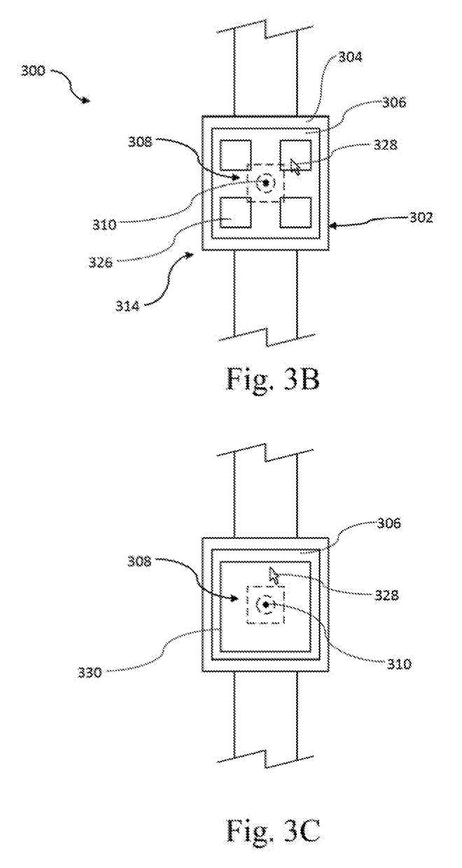

Referring now to FIG. 3A, a front view of an example wearable computing device 300 is illustrated. Wearable computing device 300 may be similar to wearable computing device 100. Further, the similarly named elements of device 300 may be similar in function to the elements of wearable computing device 100, as they are described above. A computing device portion 314 of wearable computing device 300 may include a machine-readable storage medium 318 encoded with instructions that are executable by a processor 312. The encoded instructions may include input receiving instructions 320 and revised image outputting instructions 322.

The machine-readable storage medium 316 may be an electronic, magnetic, optical, or other physical device that is capable of storing instructions. The machine-readable storage medium 318 may further enable a machine or processor to read the stored instructions and to execute them. In some implementations, the machine-readable storage medium 318 may be a non-volatile semiconductor memory device. In further implementations, the machine-readable storage medium 318 may be a Read-Only Memory (ROM) device. The machine-readable storage medium 318 may be contained within the computing device portion 314. Further, the machine-readable storage medium 318 may be attached to or contained within the processor 312. Additionally, in some implementations, the machine-readable storage medium may be disposed on an articulation portion 304 or a base portion 302. In yet further implementations, the machine-readable storage medium 318 may be enclosed within an external case, shell, or side bezel included in the base portion 302.

The machine-readable storage medium 318 may include and be encoded with input receiving instructions 320 executable by the processor 312. The input receiving instructions 320 may be instructions for receiving an articulation sensor input 324 from an articulation sensor 308, the input based on a detected articulation direction, a perpendicular translation of the articulation portion 304, or a detected substantially perpendicular force input. The input receiving instructions 320 may instruct the processor 312 to receive and identify the articulation sensor input 324 and to execute the revised image outputting instructions 322 based on the received input 324. The received input may be an input in response to the articulation sensor 308 detecting an articulation direction of the articulation portion 304. The direction of the articulation may identify the location of the force input causing the articulation of the articulation portion 304. Further, the received input may be an input in response to the articulation sensor 308 detecting the perpendicular force input to the center of a display 306, or detecting the translation of the articulation portion 304 as a result of such a force input.

The machine-readable storage medium 318 may further include and be encoded with revised image outputting instructions 322 executable by the processor 312. The revised image outputting instructions 322 may be instructions for outputting a revised image on a graphical user interface in response to the processor 312 receiving the input from the articulation sensor 308. Upon the processor 312 receiving and identifying the input from the articulation sensor 308 in accordance with the input receiving instructions 320, the processor 312 may execute the revised image outputting instructions 322 based on whether the received input was a detected articulation direction, a detected perpendicular force input applied to the center of the display 306, or a detected perpendicular translation of the articulation portion 304. The revised image outputting instructions 322 may then cause the processor 312 to output a revised image on the graphical user interface. The revised image may include visual changes to the graphical user interface, the visual changes corresponding to the input received from the articulation sensor 308. In other words, in some implementations, the revised image outputting instructions 322 may include separate instructions for outputting a revised image that correspond to a detected articulation direction, a perpendicular force input applied to the center of the display 306, and the perpendicular translation of the articulation portion 304.

Referring now to FIG. 3B, a front view of the example wearable computing device 300 is illustrated. In some implementations, the image output by the processor 312 on the graphical user interface may include a visual cursor 328. In further implementations, the visual cursor 328 may be an arrow, pointer, hand, or another indicating and/or selection icon, symbol, or graphic. The image output by the processor 312 on the graphical user interface may further include one or more icons 326 representing executable computerized applications or computing device functions that can be performed by the wearable computing device 300. In some implementations, the one or more icons 326 may not represent separate executable computerized applications, but instead represent different selectable options or answers to questions or choices (e.g., Yes/No, Enter/Cancel).

In some implementations, the revised image output by the processor 312 on the graphical user interface upon the processor 312 receiving an input from the articulation sensor 308 may also include the visual cursor 328 and one or more icons 326. In implementations where the input 324 from the articulation sensor 308 corresponds to the detected articulation direction of the articulation portion 304, the revised image may include the visual cursor 328 in a new or different location on the graphical user interface than prior to the processor 312 receiving the input from the articulation sensor 308. The new location of the visual cursor 328 may correspond to the articulation direction. In further implementations, the new location of the visual cursor 328 may be in the same direction as the detected articulation direction of the articulation portion 304. In other words, the visual cursor 328 may move on the graphical user interface upon a force input causing the articulation portion 304 to articulate, the movement of the visual cursor 328 being in the same direction as the articulation. The user may cause the movement of the visual cursor 328 to move it towards an icon 326 in order to “hover” over it, or otherwise be in a portion to “click” or select the application or function that the icon 326 represents, as shown in FIG. 3B. In some implementations, the new location of the visual cursor 328 may be towards the force input causing the articulation of the articulation portion 304. In yet further implementations, the new location of the visual cursor 328 may be in the opposite direction as the detected articulation direction of the articulation portion 304. In particular, the visual cursor 328 may move in an “inverse aiming” manner upon a force input causing the articulation of the articulation portion 304.

Referring now to FIG. 3C, a front view of the example wearable computing device 300 is shown. In addition to the elements illustrated in FIG. 3B, the wearable computing device 300 may further include a visual representation 330 of a secondary function of the processor 312 on the graphical user interface on the display 306. In some implementations, the revised image may include the visual representation 330 of a secondary function of the processor 312 when the input from the articulation sensor 308 corresponds to the substantially perpendicular force input applied to the display 306. In further implementations, the revised image may include the visual representation 330 of a secondary function when the input from the articulation sensor 308 corresponds to the detected substantially perpendicular translation of the articulation portion 304. In some implementations, the secondary function itself may correspond to the substantially perpendicular force input applied to the display 306 or the detected substantially perpendicular translation of the articulation portion 304. In some implementations, the visual representation 330 of a secondary function may be the selection of an executable computerized application or computing device function. In further implementations, the secondary function will only activate if the visual cursor 328 is concurrently positioned over an icon 326, or the visual cursor 328 is otherwise selecting an application or function. In some applications, the detected force input applied to the display, or the detected translation of the articulation portion 304 will “click” a selected icon 326, the “click” or launching of the application or function represented by the selected icon 326 being the visual representation 330 of a secondary function on the graphical user interface.

What is claimed is:

1. A wearable computing device, comprising:
a processor;
a base portion;
an articulation portion movably coupled to the base portion and including a display with a graphical user interface to display an image to the user; and
an articulation sensor movably coupling the articulation portion to the base portion and disposed between the articulation portion and the base portion, substantially centered behind the display, the articulation sensor to detect an articulation direction of the articulation portion and to provide an input to the processor based on the detected direction,
wherein the processor is to output a revised image on the graphical user interface corresponding to the provided input.

2. The wearable computer device of claim 1, wherein the articulation portion is to articulate relative to the base portion about a single point upon the user applying a force input to a single location along the periphery of the display, the articulation portion to articulate in a direction towards the location of the force input.

3. The wearable computing device of claim 2, wherein the graphical user interface includes a visual cursor, the revised image including the visual cursor in a new location corresponding to the articulation direction.

4. The wearable computing device of claim 3, wherein the new location of the visual cursor is in the same direction as the articulation direction.

5. The wearable computing device of claim 1, wherein the articulation sensor is to detect a force input applied to a single location substantially in the center of the display and provide an input to the processor based on the detected force input.

6. The wearable computer device of claim 5, wherein the revised image includes a visual representation of a secondary function of the processor, the secondary function of the processor corresponding to the force input.

7. The wearable computing device of claim 5, wherein the articulation portion is to translate in a substantially perpendicular direction relative to the base portion upon the user applying the force input to a single location substantially in the center of the display.

8. The wearable computer device of claim 7, wherein the articulation sensor is to detect the substantially perpendicular translation of the articulation portion and provide an input to the processor based on the detected translation.

9. The wearable computing device of claim 8, wherein the revised image includes a visual representation of a secondary function of the processor, the secondary function corresponding to the detected translation.

10. A wearable computing device, comprising:
an attachment mechanism to removably fix the wearable computing device to a user; and
a computing device portion coupled to the attachment mechanism and including:
a base portion;
an articulation portion having a display with a graphical user interface to display an image to the user, the articulation portion movably coupled to the base portion;
an articulation sensor movably coupling the articulation portion to the base portion and disposed between the articulation portion and the base portion,
substantially centered behind the display; and
a processor to receive an input from the articulation sensor and to output a revised image on the graphical user interface corresponding to the input from the articulation sensor.

11. The wearable computing device of claim 10, wherein the articulation sensor is to detect a force input applied to a single location substantially in the center of the display and provide an input to the processor based on the detected force input.

12. The wearable computing device of claim 11, wherein the revised image includes a visual representation of a secondary function of the processor, the secondary function corresponding to the detected force input.

13. The wearable computing device of claim 10, wherein the attachment mechanism is a wrist strap.

14. A wearable computing device, comprising:
a wrist strap to removably fix the wearable computing device to a user; and
a computing device portion coupled to the wrist strap and including:
a processor;
a base portion;
an articulation portion movably coupled to the base portion and including a display with a graphical user interface to display an image with a visual cursor, the articulation portion to articulate relative to the base portion about a single point behind the center of the display upon the user applying a force input to a single location along the periphery of the display, the articulation portion to articulate in a direction towards the location of the force input; and
an articulation sensor movably coupling the articulation portion to the base portion and disposed between the articulation portion and the base portion, substantially centered behind the display,
wherein the articulation sensor is to detect an articulation direction of the articulation portion and provide an input to the processor corresponding to the detected direction.

15. The wearable computer device of claim 14, wherein the processor is to output a revised image on the graphical user interface corresponding to the provided input, the revised image including the visual cursor in a new location corresponding to the articulation direction.
